(19) United States
(12) Patent Application Publication
(10) Pub. No.: US 2007/0115219 A1
(43) Pub. Date: May 24, 2007

(54) Apparatus for driving plasma display panel and plasma display

(75) Inventor: Manabu Inoue, Kyoto (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/283,692

(22) Filed: Nov. 22, 2005

(51) Int. Cl. G09G 3/28

(52) U.S. Cl. 345/68

(57) ABSTRACT

A PDP driving apparatus drives a plasma display panel (PDP) having sustain electrodes, scan electrodes, and address electrodes. The PDP driving apparatus includes a high side switch element and a low side switch element, those electrically coupled in series. A specific pulse voltage is applied from a junction point of the high side switch element and the low side switch element to at least sustain electrodes, scan electrodes, or address electrodes of the plasma display panel. At least one of the high side switch element and the low side switch element is a bidirectional switch element.

### BACKGROUND OF THE INVENTION

1. Field of the Invention

The invention relates to a driving apparatus of plasma display panel.

2. Related Art

Plasma display is a display device making use of light emitting phenomenon by gas discharge. The display portion of the plasma display, that is, a plasma display panel (PDP) is more advantageous than other display devices in the aspect of large screen, thin panel, and wide viewing angle. PDP is roughly classified into DC type operated by direct-current pulses, and AC type operated by alternating-current pulses. The AC type PDP is particularly high in luminance, and simple in structure. Therefore, the AC type PDP is suited to mass production and finer pixel size, and is used in a wide range.

An AC type PDP has, for example, a three-electrode surface discharge structure (see, for example, patent document 1). In this structure, address electrodes are disposed on a back surface of PDP in longitudinal direction of the panel, and sustain electrodes and scan electrodes are disposed on a front surface of the PDP alternately in lateral direction of the panel. The address electrode and scan electrode can be generally controlled for the potential individually one by one.

At the intersection of a pair of mutually adjacent sustain electrode and scan electrode and the address electrode, a discharge cell is formed. On the surface of the discharge cell, a layer made of dielectric (dielectric layer), a layer for protecting electrode and dielectric layer (protective layer), and a layer including phosphor (phosphor layer) are provided. The inside of the discharge cell is filled with gas. When discharge occurs in the discharge cell by application of a pulse voltage to the sustain electrode, scan electrode and address electrode, molecules of the gas are ionized to emit ultraviolet rays. The ultraviolet rays excite the phosphor on the discharge cell surface to generate fluorescence. As a result, the discharge cell emits light.

A PDP driving apparatus generally controls potentials of sustain electrode, scan electrode and address electrode of the PDP according to ADS (address display-period separation) method. The ADS method is one of sub-field methods. In the sub-field method, one field of image is divided into plural sub-fields. A sub-field includes a reset period, an address period, and a sustain period. In the ADS method, in particular, these three periods are set commonly in all discharge cells of the PDP (see, for example, JP2005-70787, A).

In the reset period, a reset pulse voltage is applied between the sustain electrode and scan electrode. As a result, wall charge is made uniform in all discharge cells.

In the address period, a scan pulse voltage is sequentially applied to the scan electrode, and a signal pulse voltage is applied to some of the address electrodes. Herein, the address electrodes to which the signal pulse voltage is applied are selected on the basis of a video signal entered from outside. When a scan pulse voltage is applied to one scan electrode and signal pulse voltage is applied to one address electrode, discharge occurs in the discharge cell positioned at the intersection of such scan electrode and address electrode. By this discharge, the wall charge is accumulated on the discharge cell surface.

In the sustain period, a sustain pulse voltage is applied to all pairs of sustain electrode and scan electrode simultaneously and periodically. At this time, in the discharge cell in which the wall charge is accumulated in address period, discharge by gas continues and luminance occurs. Duration of sustain period varies in each sub-field, and the light emitting time per field of discharge cell, that is, the luminance of discharge cell is adjusted by selection of sub-field to be emitted.

FIG. 8 shows a structure of a conventional PDP driving apparatus. In particular, the scan electrode driving section and PDP are shown in FIG. 8. The scan electrode driving section 110 includes a scan pulse generating section 111, a reset pulse generating section 112, and a sustain pulse generating section 113. The sustain pulse generating section 113 includes a high side sustain switch element Q7Y and a low side sustain switch element Q8Y connected in series, and controls, through these sustain switch elements Q7Y and Q8Y, a voltage between the sustain electrode X and scan electrode Y by sustain voltage source Vs or ground potential. The PDP 20 is equivalently expressed by a floating capacity Cp (hereinafter called “PDP panel capacity”) between the sustain electrode X and scan electrode Y, and a path of current flowing in the PDP 20 on discharge in the discharge cell is omitted. In FIG. 8, a sustain electrode driving section connected to the sustain electrodes X is omitted, and the sustain electrodes X are shown as in grounded state in the diagram.

In order to make uniform the wall charge in all discharge cells in the PDP during reset period, the upper limit of reset pulse voltage must be sufficiently higher. To cause address discharge in the address period, the lower limit of the scan pulse voltage must be sufficiently lower. Therefore, the upper limit of reset pulse voltage is generally set higher than the upper limit of the sustain pulse voltage. The lower limit of the scan pulse voltage is generally set lower than the lower limit of the sustain pulse voltage. Therefore, to prevent the reset pulse voltage from being clamped by the upper limit of the sustain pulse voltage, in the reset period, the sustain voltage source of the sustain pulse generating section must be separated from the reset pulse generating section. To prevent the scan pulse voltage from being clamped by the lower limit of the sustain pulse voltage, in the address period, the sustain voltage source of the sustain pulse generating section must be separated from the scan pulse generating section.

In the conventional PDP driving apparatus, separate switch elements QS1 and QS2 are installed between the sustain voltage source Vs and reset pulse generating section 112. In the example in FIG. 8, separate switch elements QS1 and QS2 are inserted.

In the sustain period, the separate switch elements QS1 and QS2 are turned on, and by switching of sustain switch elements Q7Y and Q8Y of the sustain pulse generating section 113, positive or negative potential of the sustain voltage source Vs are supplied from an output terminal JY2 of the sustain pulse generating section 113.

In the reset period, the separate switch elements QS1 and QS2 are turned off, and the reset pulse generating section is separated from the sustain voltage source Vs.

Thus, the reset pulse voltage is not clamped by the upper limit or lower limit of the sustain pulse voltage, but ascends to a specified upper limit, or descends to a specified lower limit. In the reset period, therefore, a sufficient voltage for making the wall charge uniform is applied to all discharge cells of the PDP.

However, in the separate switch elements QS1 and QS2, during the sustain period, a current flows that caused by application of a sustain pulse voltage (a current by discharge in discharge cells of the PDP). This current is generally larger than the current due to application of other pulse voltage, and it is hence important to lower the conduction loss in the separate switch elements in order to save power consumption in the PDP driving apparatus. In particular, the current capacity of separate switch elements must be set larger. Therefore, a multiplicity of separate switch elements are connected in parallel, and the mounting area of separate switch elements is increased. As a result, it has been difficult to save power consumption and curtail the number of parts at the same time.

Further, in the conventional PDP driving apparatus, during the sustain period, the electric power of the panel capacity Cp is recovered by a resonance circuit composed of recovery switch elements Q9Y and Q10Y, recovery diodes D1 and D2, a recovery inductor CY, and a recovery capacitor LY. The diodes D1 and D2 block the current flowing into the recovery capacitor when sustain switch elements Q7Y and Q8Y are on, thereby keeping the recovery capacitor CY at a constant voltage (Vs/2).

However, since the recovery current flowing by recovery operation is a very large current, it is important to reduce the conduction loss in the recovery diodes in order to save power consumption in the PDP driving apparatus. In particular, the current capacity of recovery diodes must be set large enough. Therefore, a multiplicity of recovery diodes must be connected in parallel, and thus the mounting area of recovery diodes is increased. As a result, it has been difficult to save power consumption and curtail the number of parts at the same time.

The invention is devised to solve the problems, and it is hence an object thereof to present a PDP driving apparatus saved in power consumption and curtailed in the number of parts, without decreasing the voltage of the reset pulse etc. to be applied between electrodes of the PDP.

### SUMMARY OF THE INVENTION

The invention provides a driving apparatus of a plasma display panel capable of displaying images by light emission by discharge between electrodes, including an electrode driving section operable to apply a specific voltage to electrodes, in which the electrode driving section includes a bidirectional switch element.

More specifically, in a first aspect of the invention, provided is a driving apparatus of a plasma display panel having sustain electrodes, scan electrodes, and address electrodes. The driving apparatus includes a high side switch element and a low side switch element, those electrically coupled in series. A specific pulse voltage is applied from a junction point of the high side switch element and the low side switch element to at least scan electrodes, sustain electrodes, or address electrodes of the plasma display panel. At least one of the high side switch element and the low side switch element is a bidirectional switch element.

In a second aspect of the invention, provided is a driving apparatus of a plasma display panel having sustain electrodes, scan electrodes, and address electrodes. The driving apparatus includes a high side switch element and a low side switch element, those electrically coupled in series. A specific pulse voltage is applied from a junction point of the high side switch element and the low side switch element to at least scan electrodes, sustain electrodes, or address electrodes of the plasma display panel. A separate switch element is provided between the junction and the plasma display panel. This separate switch element is a bidirectional switch element.

In a third aspect of the invention, provided is a driving apparatus of a plasma display panel having sustain electrodes, scan electrodes, and address electrodes. The driving apparatus includes an inductor electrically coupled to at least sustain electrodes, scan electrodes, or address electrodes, and a recovery switch element. This recovery switch element is a bidirectional switch element and forms, in ON period, a path of flow of a resonance current by the inductor and the plasma display panel.

The bidirectional switch element includes, for example, at least one of JFET, MESFET, reverse blocking IGBT, and bidirectional lateral MOSFET. The bidirectional switch element may be formed in wide band gap semiconductor. The wide band gap semiconductor contains at least one of silicon carbide, diamond, gallium nitride, and zinc oxide.

A fourth aspect of the invention relates to a plasma display having a plasma display panel, and the above driving apparatus for driving the plasma display panel.

### EFFECTS OF THE INVENTION

The PDP driving apparatus of the invention uses a bidirectional switch element which can control current flow in both directions from the drain to the source and from the source to the drain. Thus the separate switch elements, recovery diodes, or the parts contained in them can be reduced in number, while the scan pulse voltage, reset pulse voltage, and sustain pulse voltage can be applied to the PDP same as in the prior art. As a result, according to the invention, the PDP driving apparatus can be reduced in size. The mounting area is also decreased, and the wiring impedance can be lowered. Further, conduction loss by separate switch elements or recovery diodes in the sustain period is substantially decreased, thereby resulting in a greater power saving.

### BRIEF DESCRIPTION OF DRAWINGS

FIG. 1 is a block diagram of a structure of a plasma display in an embodiment of the invention.

FIG. 2 is an equivalent circuit diagram of a scan electrode driving section and a PDP in embodiment 1 of the invention.

FIG. 3 is a diagram showing an applied voltage waveform of a scan electrode of the PDP during a reset period, an address period, and a sustain period, and a diagram showing ON periods of switch elements included in the scan electrode driving section in embodiment 1 of the invention.

FIG. 4 is an equivalent circuit diagram of a scan electrode driving section and a PDP in embodiment 2 of the invention.

FIG. 5 is a diagram showing an applied voltage waveform of a scan electrode of the PDP during a reset period, an address period, and a sustain period, and a diagram showing ON periods of switch elements included in the scan electrode driving section in embodiment 2 of the invention.

FIG. 6 is an equivalent circuit diagram of a scan electrode driving section and a PDP in embodiment 3 of the invention.

FIG. 7 is a diagram showing an applied voltage waveform of a scan electrode of the PDP during a reset period, an address period, and a sustain period, and a diagram showing ON periods of switch elements included in the scan electrode driving section in embodiment 3 of the invention.

FIG. 8 is an equivalent circuit diagram of a scan electrode driving section and a PDP in a conventional PDP driving apparatus.

### DETAIL DESCRIPTION OF PREFERRED EMBODIMENT

Referring now to the drawings, preferred embodiments of the invention are described below.

### Embodiment 1

1.1 Configuration

1.1.1 Plasma Display

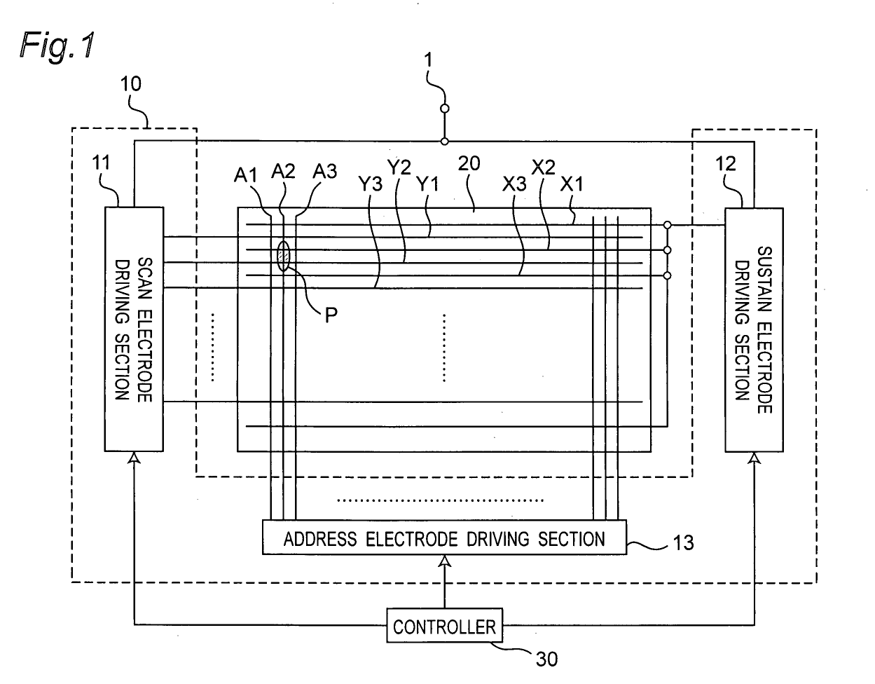

FIG. 1 is a block diagram showing a configuration of a plasma display in an embodiment of the invention. The plasma display includes a PDP driving apparatus 10, a plasma display panel (PDP) 20, and a controller 30.

(Plasma Display Panel)

The PDP 20 is, for example, of AC type, having three-electrode surface discharge type structure. On a back surface of the PDP 20, address electrodes A1, A2, A3, . . . are disposed along the width direction of the panel. On a front surface of the PDP 20, sustain electrodes X1, X2, X3, . . . and scan electrodes Y1, Y2, Y3, . . . are disposed alternately along the longitudinal direction of the panel. The sustain electrodes X1, X2, X3, . . . are mutually coupled to be substantially equal in the potential. The address electrodes A1, A2, A3, . . . , and scan electrodes Y1, Y2, Y3, . . . can be controlled individually for the potential.

A discharge cell is disposed at an intersection (for example, shaded area P in FIG. 1) of a pair of mutually adjacent sustain electrode and scan electrode (for example, a pair of sustain electrode X2 and scan electrode Y2) and an address electrode (for example, address electrode A2). The surface of the discharge cell includes a layer of dielectric (dielectric layer), a layer for protecting the electrodes and dielectric layer (protective layer), and a layer of phosphor (phosphor layer). The inside of the discharge cell is filled with gas. Application of a specified voltage to the sustain electrode, scan electrode, and address electrode causes discharge in the discharge cell. At this time, gas molecules in the discharge cell are ionized to emit ultraviolet rays. The ultraviolet rays excite the phosphor on the discharge cell surface to generate fluorescence. As a result, the discharge cell emits light.

(PDP Driving Apparatus)

The PDP driving apparatus 10 includes a scan electrode driving section 11, a sustain electrode driving section 12, and an address electrode driving section 13.

The scan electrode driving section 11 and an input terminal 1 of the sustain electrode driving section 12 are connected to a power supply unit (not shown). The power supply unit first converts an alternating-current voltage from an external commercial power source to a specific direct-current voltage (for example, 400V). The direct-current voltage is further converted into a specified direct-current voltage Vs by a DC-DC converter. The direct-current voltage Vs is applied to the PDP driving apparatus 10. As a result, the potential at the input terminal 1 maintained higher than ground potential (about zero) by direct-current voltage Vs.

Output terminals of the scan electrode driving section 11 are individually connected to scan electrodes Y1, Y2, Y3, . . . of the PDP 20. The scan electrode driving section 11 changes each potential of scan electrodes Y1, Y2, Y3, . . . individually.

Output terminals of the sustain electrode driving section 12 are individually connected to sustain electrodes X1, X2, X3, . . . of the PDP 20. The sustain electrode driving section 12 changes uniformly potentials of sustain electrodes X1, X2, X3, . . . .

The address electrode driving section 13 is connected to address electrodes A1, A2, A3, . . . of the PDP 20 individually. The address electrode driving section 13 generates a signal pulse voltage on the basis of a video signal from outside, and applies it to electrodes selected from address electrodes A1, A2, A3, . . . .

The PDP driving apparatus 10 controls the potential of each electrode of the PDP 20 according to the ADS (Address Display-period Separation) method which is one of sub-field methods. For example, in television broadcast in Japan, one field of image is sent at intervals of 1/60 second (about 16.7 msec). Therefore, the display time per field is constant. In the sub-field method, one field is divided into plural sub-fields. Further, in each sub-field, three periods (reset period, address period, and sustain period) are set commonly in all discharge cells of the PDP 20. Duration of the sustain period differs in each sub-field. In the reset period, address period, and sustain period, different pulse voltages are applied to discharge cells as follows.

In the reset period, a reset pulse voltage is applied between the sustain electrodes X1, X2, X3, . . . and scan electrodes Y1, Y2, Y3, . . . . As a result, the wall charge is made uniform in all discharge cells.

In the address period, the scan electrode driving section 11 applies a scan pulse voltage sequentially to the scan electrodes Y1, Y2, Y3, . . . . Simultaneously with application of the scan pulse voltage, the address electrode driving section 13 applies a signal pulse voltage to the address electrodes A1, A2, A3, . . . . Herein, the address electrodes to be applied with the signal pulse voltage are selected on the basis of a video signal entered from outside. Application of a scan pulse voltage to one scan electrode and a signal pulse voltage to one address electrode causes discharge in the discharge cell positioned at the intersection of such scan electrode and address electrode. This discharge causes a wall charge to be accumulated on the discharge cell surface.

In the sustain period, the scan electrode driving section 11 and sustain electrode driving section 12 alternately apply sustain pulse voltages to scan electrodes Y1, Y2, Y3 . . . or sustain electrodes X1, X2, X3, . . . . At this time, the discharge continues to generate emission at the discharge cells with wall charge accumulated in the address period. Duration of the sustain period varies in each sub-field, and the light emitting time per field of discharge cell, that is, the luminance of discharge cell is adjusted by selection of sub-fields to be emitted.

The scan electrode driving section 11, sustain electrode driving section 12, and address electrode driving section 13 individually incorporate switching inverters inside. The controller 30 controls switching of these driving sections. As a result, the reset pulse voltage, scan pulse voltage, signal pulse voltage, and sustain pulse voltage are generated in specified waveform and at specified timing, individually. The controller 30, in particular, selects address electrodes to be applied with signal pulse voltages based on a video signal from outside. Further, the controller 30 determines the duration of the sustain period after application of the signal pulse voltage, that is, the sub-field to which the signal pulse voltage is to be applied. As a result, each discharge cell emits with appropriate luminance. Thus, the video image corresponding to the video signal is reproduced on the PDP 20.

1.1.2 Scan Electrode Driving Section

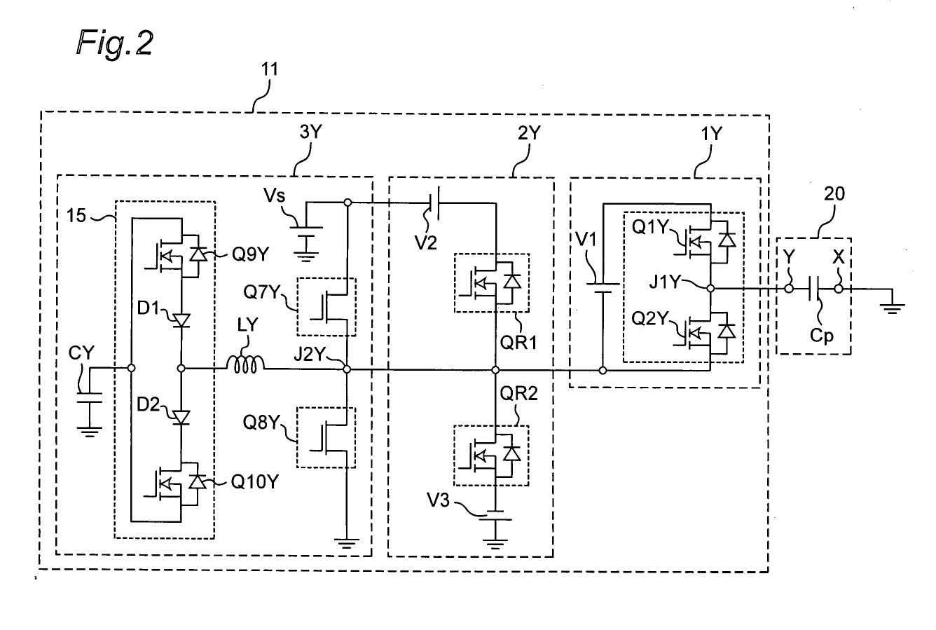

FIG. 2 specifically shows a structure of the scan electrode driving section 11. An equivalent circuit of the PDP 20 is also shown in FIG. 2. The scan electrode driving section 11 includes a scan pulse generating section 1Y, a reset pulse generating section 2Y, and sustain pulse generating, section 3Y. The PDP 20 is equivalently expressed by a floating capacity Cp (PDP panel capacity) between the sustain electrode X and scan electrode Y. A path of a current flowing in the PDP 20 on discharge at the discharge cell is not shown. In FIG. 2, the sustain electrode driving section connected to the sustain electrode X is omitted, and the sustain electrode X is shown in grounded state in the diagram.

(Scan Pulse Generating Section)

The scan pulse generating section 1Y includes a first constant voltage source V1, a high side scan switch element Q1Y, and low side scan switch element Q1Y.

The first constant voltage source V1 maintains the positive potential thereof higher than the negative potential by specified voltage V1 on the basis of the direct-current voltage Vs applied from the power supply unit, using, for example, a DC-DC converter (not shown).

The two scan switch elements Q1Y and Q2Y are, for example, MOS FETs. They may be also IGBTs or bipolar transistors.

The positive electrode of the first constant voltage source V1 is connected to the drain of the high side scan switch element Q1Y. The source of the high side scan switch element Q1Y is connected to the drain of the low side scan switch element Q2Y. The junction J1Y of them is connected to one scanning electrode Y of the PDP 20. The source of the low side scan switch element Q2Y is connected to the negative electrode of the first constant voltage source V1.

Herein, the series connection circuits (portion enclosed by solid line in FIG. 2) of the high side scan switch element Q1Y and low side scan switch element Q2Y are actually provided as many as the number of scan electrodes Y1, Y2, . . . , and are individually connected to the scan electrodes Y1, Y2, . . . .

(Reset Pulse Generating Section)

The reset pulse generating section 2Y includes a second constant voltage source V2, a high side lamp waveform generating section QR1, a low side lamp waveform generating section QR2, and a third constant voltage source V3.

The second constant voltage source V2 maintains a potential of the positive electrode higher than the direct-current voltage Vs applied, for example, from the power supply unit by the DC-DC converter, by specified voltage V2.

The third constant voltage source V3 maintains a potential of the positive electrode higher than a potential of the negative electrode by specified voltage V3 on the basis of direct-current voltage Vs applied from the power supply unit, using, for example, a DC-DC converter.

The lamp waveform generating sections QR1 and QR2 include, for example, N-channel MOS FET (NMOS). The gate and drain of the NMOS are connected via a capacitor. When the lamp waveform generating sections QR1 and QR2 are turned on, the voltage between the drain and source changes to zero substantially at constant speed.

The positive electrode of the second constant voltage source V2 is connected to the drain of the high side lamp waveform generating section QR1. The source of the high side lamp waveform generating section QR1 is connected to the negative electrode of the first constant voltage source V1. The negative electrode of the second constant voltage source V2 is connected to the positive electrode of the sustain voltage source Vs of the sustain pulse generating section 3Y. The drain of the low side lamp waveform generating section QR2 is connected to the negative electrode of the first constant voltage source V1, and the source of the low side lamp waveform generating section QR2 is connected to the negative electrode of the third constant voltage source V3. The positive electrode of the third constant voltage source V3 is grounded.

(Sustain Pulse Generating Section)

The sustain pulse generating section 3Y includes a series circuit of a high side sustain switch element Q7Y and a low side sustain switch element Q8Y, a recovery inductor LY, a recovery switch 15, and a recovery capacitor CY.

The sustain voltage source Vs maintains a potential of the positive electrode higher than a potential of the negative electrode by specific voltage Vs (sustain voltage). The positive electrode of the sustain voltage source Vs is connected to the drain of the high side sustain switch element Q7Y, and the source of the high side sustain switch element Q7Y is connected to the drain of the low side sustain switch element Q8Y. The source of the low side sustain switch element Q8Y is connected to the negative electrode of the sustain voltage source Vs. The negative electrode of the sustain voltage source Vs is, for example, 0V (grounded state). The junction J2Y between the high side sustain switch element Q7Y and low side sustain switch element Q8Y is connected to the negative electrode of the first constant voltage source V1 as an output terminal of the sustain pulse generating section 3Y. The path from the output terminal J2Y of the sustain pulse generating section 3Y to an anode of the low side scan switch element Q2Y is called “sustain pulse transmission path.”

(Sustain Switch Element as “Bidirectional Switch Element”)

In the sustain pulse generating section 3Y, in particular, sustain switch elements Q7Y and Q8Y are composed of bidirectional switch elements. The bidirectional switch element is an element having the following characteristics:
during ON period, it allows a current to flow in two directions, from the drain to the source, and from the source to the drain, and can control flow of the current in two directions; and
in OFF period, it does not allow a current to flow in two directions, from the drain to the source, nor from the source to the drain. That is, in OFF period, it has sufficient absolute maximum rating for drain to source voltage and source to drain voltage. Herein, the sufficient absolute maximum rating for drain to source voltage and source to drain voltage means a voltage that allows the element not to be broken down even if a voltage higher than the source voltage by specified voltage (the value is determined by the purpose) is applied to the drain, or if a voltage higher than the drain voltage by specified voltage is applied to the source.

Examples of such bidirectional switch element include JFET (Junction Field Effect Transistor), and MESFET (Metal Semiconductor Field Effect Transistor). Another example is reverse blocking IGBT (see “1200V class reverse blocking IGBT (RB-IGBT) for AC matrix converter”; by Hideki Takahashi, et al., Proceedings of 2004 International Symposium on Power Semiconductor Devices and ICs, Kitakyushu, pp. 121-124). A bidirectional lateral MOSFET may be also used. The bidirectional lateral MOSFET is MOSFET that shares two drain regions with two MOSFETs and has no drain terminal and two gate terminals (see Akio Sugi et al., “Battery protection IC integrating Bi-directional Trench Lateral Power MOSFETs”, workshop materials of Institute of Electrical Engineers of Japan, EDD-05-53/SPC-05-78, pp. 7-12, Joint Research Society of electronic devices and semiconductor power conversion, Oct. 27-28, 2005, Fukui University). In particular, the bidirectional switch element can have the absolute maximum rating for drain to source voltage and source to drain voltage, and thus the element is enhanced in absolute maximum rating for drain to source voltage and source to drain voltage. Therefore, a wide band gap semiconductor is effective for suppressing elevation of turn-on resistance Ron. Herein, the wide band gap semiconductor is a semiconductor having a gap wider than silicon (Si). Examples of materials of wide band gap semiconductors include silicon carbide (SiC), diamond, gallium nitride (GaN), zinc oxide (ZnO), and other wide band gap semiconductors. Since the wide band gap semiconductors are small in turn-on resistance, they are advantageous also from the viewpoint of power loss. Otherwise, those having similar characteristics may be also used as bidirectional switch elements.

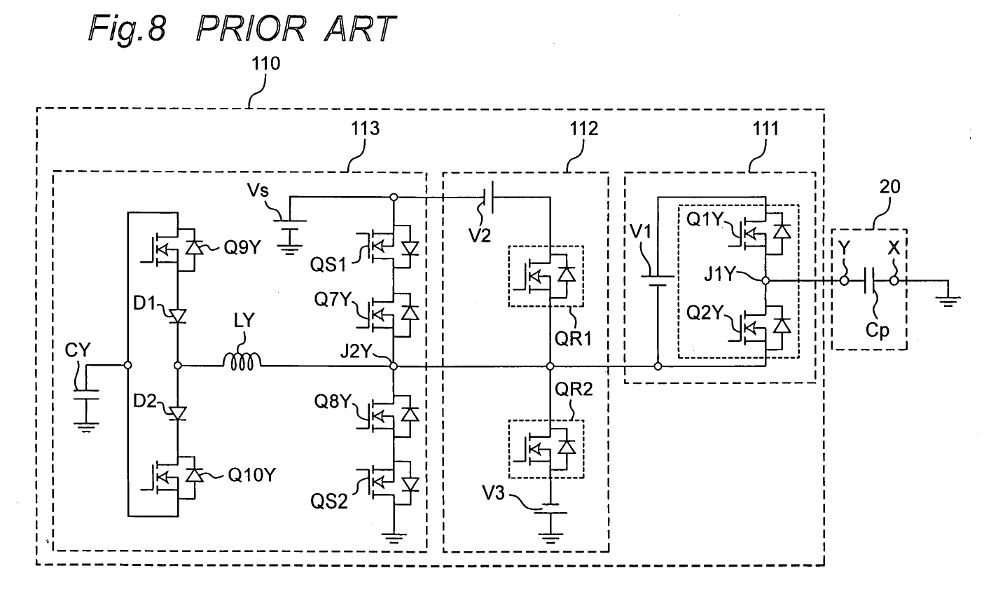

By achieving the sustain switches Q7Y and Q8Y by bidirectional switch elements, reverse conduction can be blocked if a high voltage is applied to the sustain switches Q7Y and Q8Y. Hence, by achieving the sustain switches Q7Y and Q8Y by bidirectional switch elements, in the conventional PDP driving apparatus, it is not required to use separation switch (see FIG. 8) employed in the conventional PDP driving apparatus for blocking reverse conduction in the reset period. Thus the number of parts can be curtailed, and the power loss can be reduced. It is noted that one of the sustain switches Q7Y and Q8Y may be formed of a bidirectional switch element, and the other may be formed of, for example, MOS FET, IGBT, or bipolar transistor. If not using bidirectional switch element, a separation switch element has to be provided to a sustain switch element that is not a bidirectional switch. In this case, the source of sustain switch element (Q7Y or Q8Y) and the source of separation switch element (QS1 or QS2) are connected. Alternatively, the drain of the sustain switch element (Q7Y or Q8Y) and the drain of separation switch element (QS1 or QS2) may be connected. The separation switch element can be applied, not only to the scan electrode (scan electrode driving section 11), but also to the sustain electrode (sustain electrode driving section 12) and the address electrode (address electrode driving section 13).

(Recovery Switch Circuit)

The recovery switch circuit 15 includes a first recovery diode D1, a second recovery diode D2, a high side recovery switch element Q9Y, and a low side recovery switch element Q10Y. The two recovery switch elements Q9Y and Q10Y are, for example, MOSFETs. They may also be IGBTs or bipolar transistors.

The source of the high side recovery switch element Q9Y is connected to an anode of the first recovery diode D1, a cathode of the first recovery diode D1 is connected to an anode of the second recovery diode D2, and a cathode of the second recovery diode D2 is connected to the drain of the low side recovery switch element Q10Y. One end of a recovery inductor LY is connected to a junction J2Y, and the other end is connected to the cathode of the first recovery diode D1. One end of the recovery capacitor CY is connected to a negative electrode of the sustain voltage source Vs, and the other end is connected to the drain of the high side recovery switch element Q9Y and the source of the low side recovery switch element Q10Y.

The capacity of the recovery capacitor CY is sufficiently larger than the panel capacity Cp of the PDP 20. The voltage across the recovery capacitor CY is maintained substantially same as a half (Vs/2) of a direct-current voltage Vs applied from the power supply unit.

1.2 Operation

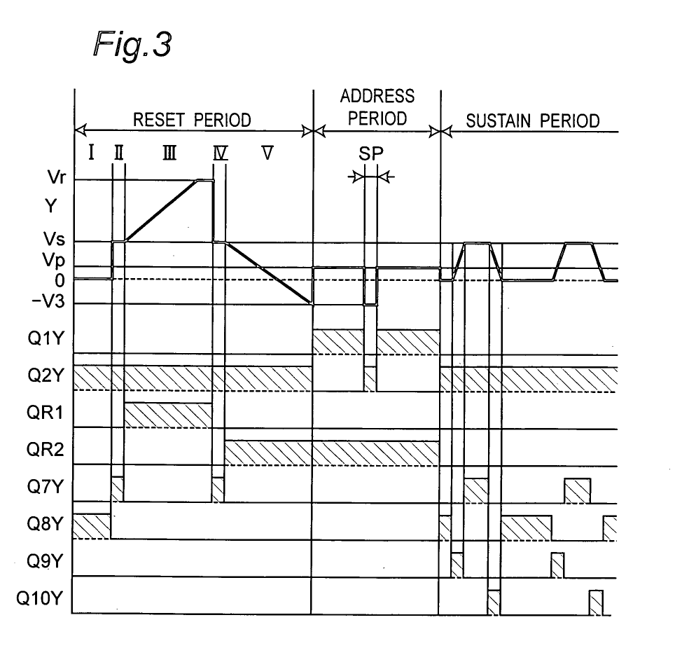

FIG. 3 is an applied voltage waveform diagram of the scan electrode Y of the PDP 20 during the reset period, address period, and sustain period, and a diagram showing ON period of each switch element included in the scan electrode driving section 11. In FIG. 3, the ON period of each switch element is indicated in shaded area. The operation in each period is explained below.

1.2.1 Reset Period

The reset period is divided into five modes I to V as follows depending on change in reset pulse voltage.

<Mode I>

In the scan electrode driving section 11, the low side scan switch element Q2Y and low side sustain switch element Q8Y are maintained in ON state. The other switch elements are maintained in OFF state. As a result, the scan electrode Y is maintained at ground potential (about zero).

<Mode II>

In the scan electrode driving section 11, the low side, scan switch element Q2Y and high side sustain switch element Q7Y are maintained in ON state. The other switch elements are maintained in OFF state. As a result, the potential of the scan electrode Y is elevated to a potential higher than ground potential (about zero) by voltage Vs of the sustain voltage source Vs.

<Mode III>

In the scan electrode driving section 11, while the low side scan switch element Q2Y is maintained in ON state, the high side sustain switch element Q7Y is turned off, and the high side lamp waveform generating section QR1 is turned on. The other switch elements are maintained in OFF state. As a result, the potential of the scan electrode Y is elevated at a specific speed to a potential Vr (hereinafter called “upper limit of the reset pulse voltage”) higher than ground potential (about zero) by sum of a voltage Vs of the sustain voltage source Vs and a voltage V2 of the second constant voltage source.

Thus, the applied voltage is uniformly elevated in all discharge cells of the PDP 20 relatively slowly to the upper limit Vr of the reset pulse voltage. As a result, a uniform wall charge is accumulated in all discharge cells of the PDP 20. At this time, since the elevation speed of the applied voltage is small, luminance of discharge cells is suppressed very low.

<Mode IV>

In the scan electrode driving section 11, while the low side scan switch element Q2Y is maintained in ON state, the high side lamp waveform generating section QR1 is turned off, and the high side sustain switch element Q7Y is turned on (other switch elements are maintained in OFF state). As a result, the potential of the scan electrode Y descends to a potential higher by voltage Vs of the sustain voltage source Vs with respect to ground potential (about zero).

<Mode V>

In the scan electrode driving section 11, while the low side scan switch element Q2Y is maintained in ON state, the high side sustain switch element Q7Y is turned off, and the low side lamp waveform generating section QR2 is turned on. The other switch elements are maintained in OFF state. As a result, the potential of the scan electrode Y descends, at a specific speed, to a potential −V3 lower by voltage V3 of the third constant voltage source with respect to ground potential (about zero). Therefore, in the discharge cell of the PDP 20, a voltage with reverse polarity of the applied voltage in modes II to IV is applied. In particular, the applied voltage descends slowly. Hence, the wall charge in all discharge cells is removed equally to be made uniform. At this time, since the descending speed of the applied voltage is small, light emission of the discharge cell is suppressed low.

1.2.2 Address Period

During the address period, in the scan electrode driving section 11, the low side lamp waveform generating section QR2 and high side scan switch element Q1Y are maintained in ON state. Therefore, the drain of the high side scan switch element Q1Y is maintained at potential Vp higher than −V3 by voltage V1 of the first constant voltage source (hereinafter called “upper limit of the scan pulse voltage”), and the source of the low side scan switch element Q2Y is maintained at −V3.

Upon start of the address period, in all scan electrodes Y, the high side scan switch element Q1Y is maintained in ON state, and the low side scan switch element Q2Y is maintained in OFF state. As a result, the potential of all scan electrodes Y is uniformly maintained at the upper limit Vp of the scan pulse voltage.

Successively, the scan electrode driving section 11 changes the potential of the scan electrode Y as follows (see the scan pulse voltage SP shown in FIG. 3). When one scan electrode Y is selected, the high side scan switch element Q1Y connected to this scan electrode Y is turned off, and the low side scan switch element Q2Y is turned on. As a result, the potential of this scan electrode Y is lowered to −V3. When the potential of this scan electrode Y is maintained at −V3 for a specified time, the low side scan switch element Q2Y connected to this scan electrode Y is turned off, and the high side scan switch element Q1Y is turned on. Consequently, the potential of the scan electrode Y is elevated up to the upper limit Vp of the scan pulse voltage. The scan electrode driving section 11 sequentially switches similarly and sequentially the scan switch elements Q1Y and Q2Y connected to each of the scan electrodes. Thus, the scan pulse voltage SP is sequentially applied to the scan electrodes.

During the address period, when one address electrode A is selected on the basis of the video signal entered from outside, the potential of the selected address electrode A is elevated to the upper limit Va of the signal pulse voltage for a specified time (not shown).

For example, when the scan pulse voltage SP is applied to one scan electrode Y, and the signal pulse voltage is applied to one address electrode A, a voltage between the scan electrode Y and address electrode A is higher than a voltage between other electrodes. Therefore, discharge occurs in the discharge cell positioned at the intersection of the scan electrode Y and the address electrode A. This discharge causes a new wall charge to be accumulated on the discharge cell surface.

Afterwards, in the sustain period, the scan electrode driving section 11 and sustain electrode driving section 12 (not shown) alternately apply sustain pulse voltages to the scan electrode Y and sustain electrode X (see FIG. 3). At this time, discharge continues in the discharge cell in which the wall charge is accumulated during the address period, and hence light is emitted.

1.2.3 Sustain Period

The sustain period is explained below. The low side scan switch element Q2Y is always maintained in ON state.

Immediately before the high side recovery switch element Q9Y is turned on, the low side sustain switch element Q8Y is in ON state, and a voltage across the panel capacity Cp is maintained at 0V. When the high side recovery switch element Q9Y is turned on, an LC resonance circuit is formed by the recovery capacitor CY, high side recovery switch element Q9Y, first recovery diode D1, recovery inductor LY, and panel capacity Cp. As a result, a voltage across the panel capacity Cp is increased up to Vs. The other switch elements are maintained in OFF state.

Then, the high side recovery switch element Q9Y is turned off, and the high side sustain switch element Q7Y is turned on, and a voltage across the panel capacity Cp is maintained at Vs. At this time, a voltage between the drain and source of the high side sustain switch element Q7Y is zero, thus resulting in turn-on with loss of almost zero (the other switch elements are maintained in OFF state).

After a specified time, the high side sustain switch element Q7Y is turned off, and the low side recovery switch element Q10Y is turned on (the other switch elements are maintained in OFF state), and hence an LC resonance circuit is formed by the recovery capacitor CY, low side recovery switch element Q10Y, second recovery diode D2, recovery inductor LY and panel capacity Cp. As a result, the voltage across the panel capacity Cp decreases to 0V.

When the low side recovery switch element Q10Y is turned off and the low side sustain switch element Q8Y is turned on, the voltage across the panel capacity Cp is maintained at 0V. At this time, since the voltage between drain and source of the low side sustain switch element Q8Y is zero, and thus achieving turn-on with loss of almost zero (the other switch elements are maintained in OFF state).

When the potential of the scan electrode Y rises or falls, electric power is efficiently exchanged between the recovery capacitor CY and panel capacity Cp. Thus, when the sustain pulse voltage is applied, reactive power due to charge or discharge of the panel capacity is decreased.

1.3 Summary

According to the PDP driving apparatus 10 of the present embodiment, the sustain switches Q7Y and Q8Y are composed of bidirectional switch elements, and thus can reverse conduction of sustain switches Q7Y and Q8Y in reset period can be blocked. Hence, separation switches (see FIG. 8) used in the conventional PDP driving apparatus are not needed. That is, as shown in FIG. 2, only sustain switches Q7Y and Q8Y are present in the route from the sustain voltage source Vs to the source of low side scan switch element Q2Y by way of output terminal JY2 of sustain pulse generating section 3Y. Hence, according to the embodiment, as compared with the prior art, the number of parts in the PDP driving apparatus is curtailed, and the mounting area is saved. In particular, since a large current flows in separation switch elements in the sustain period, hitherto, it was necessary to connect a multiplicity of separation switch elements in parallel, and the circuit scale can be reduced effectively in the embodiment because separation switch elements are not needed. Besides, the small mounting area decreases wiring impedance by circuit board, and ringing of high frequency component occurring at the time of application of voltage to the PDP, so that the operation margin of the PDP is expanded. Moreover, the conduction loss by separation switch elements in the sustain period is substantially reduced, and the power consumption is saved sufficiently.

In the present embodiment, for the convenience of explanation, in particular, the structure of the scan electrode driving section is described, and the concept of the invention can be similarly applied to the sustain electrode driving section and address electrode driving section (It is true for the following embodiments).

### Embodiment 2

The plasma display of this embodiment differs from embodiment 1 only in the structure of scan electrode driving section 11.

2.1 Scan Electrode Driving Section

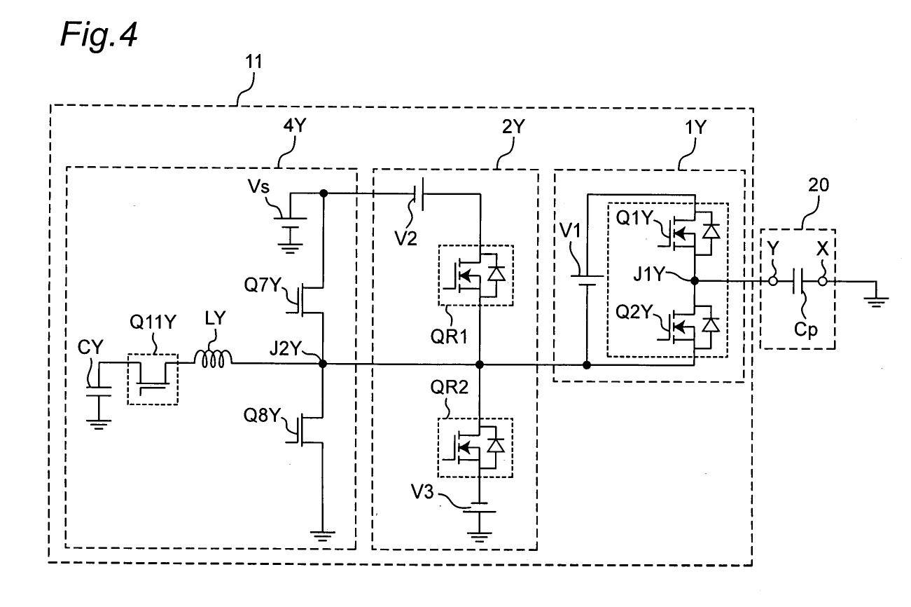

FIG. 4 shows the scan electrode driving section in embodiment 2 of the invention.

The scan electrode driving section 11 of the embodiment differs from embodiment 1 shown in FIG. 2 in the structure of the sustain pulse generating section. More specifically, the recovery switch circuit in the sustain pulse generating section is different. The other components are same as those in embodiment 1.

The sustain pulse generating section 4Y of the present embodiment is provided with a recovery switch element Q11Y instead of the recovery switch circuit 15 in the sustain pulse generating section 3Y in embodiment 1. This recovery switch element Q11Y is formed of a bidirectional switch element. The bidirectional switch element is explained in embodiment 1.

Thus, replacement of the recovery switch circuit 15 in embodiment 1 by the bidirectional switch element Q11Y causes the number of parts to be curtailed and the circuit scale to be reduced.

The recovery switch element Q11Y has its source connected to one end of the recovery inductor LY, and its drain connected to one end of the recovery capacitor CY. The other end of the recovery inductor LY is connected to the junction J2Y of sustain switches Q7Y and Q8Y, and the other end of the recovery capacitor CY is connected to the other end of the recovery capacitor CY of which one end is grounded. The recovery switch element Q11Y may also have its source connected to one end of the recovery capacitor CY, and its drain connected to one end of the recovery inductor LY.

The capacity of the recovery capacitor CY is sufficiently larger than the panel capacity Cp of the PDP 20. The voltage across the recovery capacitor CY is maintained substantially equal to a half (Vs/2) of a direct-current voltage Vs applied from the power supply unit.

In the structure in FIG. 4, the sustain switch elements Q7Y and Q8Y are not limited to be bidirectional switch elements. In such a case, same as in the prior art shown in FIG. 8, separation switch elements QS1 and QS2 must be connected to those other than the sustain switch elements Q7Y and Q8Y.

In the recovery switch circuit 15 shown in FIG. 2, either one of a series circuit of the recovery switch element Q9Y and diode D1 and a series circuit of the recovery switch element Q10Y and diode D2 may be replaced by the recovery switch element Q11Y. The recovery switch circuit 15 can be applied not only to the scan electrode (scan electrode driving section 11), but also to the sustain electrode (sustain electrode driving section 12) and address electrode (address electrode driving section 13).

2.2 Operation

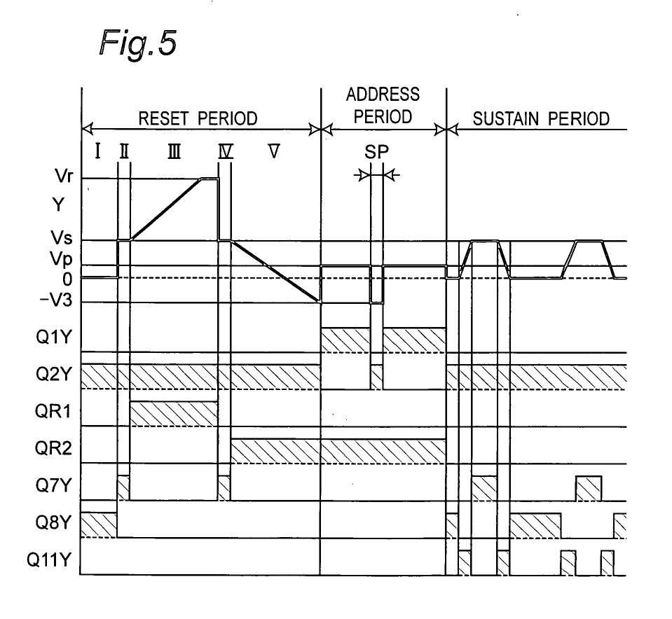

FIG. 5 is an applied voltage waveform diagram of the scan electrode Y of the PDP 20 during a reset period, an address period, and a sustain period, and a diagram showing ON period of each switch element included in the scan electrode driving section 11. In FIG. 5, the ON period of each switch element is indicated in shaded area.

2.2.1 Reset Period and Address Period

Operations of switch elements of the scan electrode driving section 11 in the reset period and address period is same as explained in embodiment 1.

2.2.2 Sustain Period

Operation in the sustain period is explained by referring to FIG. 4 and FIG. 5.

In the sustain period, the low side scan switch element Q2Y is always maintained in ON state.

Immediately before turning on the recovery switch element Q11Y, the low side sustain switch element Q8Y is ON, and the voltage across the panel capacity Cp is maintained at 0V. When the recovery switch element Q11Y is turned on, an LC resonance circuit is formed by the recovery capacitor CY, recovery switch element Q11Y, recovery inductor LY, and panel capacity Cp, and the across the panel capacity Cp is increased up to Vs (the other switch elements are maintained in OFF state).

Then the recovery switch element Q11Y is turned off, and the high side sustain switch element Q7Y is turned on. This keeps the voltage across the panel capacity Cp at Vs. At this time, since the voltage between the drain and source of the high side sustain switch element Q7Y is zero, it is turned on with loss of almost zero (the other switch elements are maintained in OFF state).

After a specified time, when the high side sustain switch element Q7Y is turned off, and the recovery switch element Q11Y is turned on, an LC resonance circuit is formed by the recovery capacitor CY, recovery switch element Q11Y, recovery inductor LY and panel capacity Cp. As a result, the voltage across the panel capacity Cp decreases to 0V (the other switch elements are maintained in OFF state).

When the recovery switch element Q11Y is turned off and the low side sustain switch element Q8Y is turned on, the voltage across the panel capacity Cp is kept at 0V. At this time, since the voltage between drain and source of the low side sustain switch element Q8Y is zero, it is turned on with a loss of almost zero (the other switch elements are maintained in OFF state).

When the potential of the scan electrode Y rises and falls, the electric power is efficiently exchanged between the recovery capacitor CY and panel capacity Cp. Thus, when the sustain pulse voltage is applied, reactive power due to charge or discharge of the panel capacity is decreased.

2.3 Summary

According to the embodiment, as shown in FIG. 4, the recovery switch circuit is formed only by the recovery switch 11 which is a bidirectional switch. That is, there is only recovery switch element Q11Y in a path extending from the recovery capacitor CY to the source of the low side scan switch element Q2Y by way of the inductor LY. Hence, in the PDP driving apparatus 10 of the embodiment, unlike the prior art, the first recovery diode D1 and second recovery diode D2 can be omitted. Hence, according to the PDP driving apparatus 10 of the embodiment, as compared with the prior art, the number of parts is curtailed, and the mounting area is saved.

In particular, since a large current flows in recovery diodes D1 and D2, usually a multiplicity of diodes are connected in parallel. Thus the meaning of eliminating the recovery diodes D1, D2 is significant. Moreover, since the conduction loss by recovery diodes D1 and D2 in the sustain period is substantially reduced, the power consumption is saved sufficiently.

### Embodiment 3

The plasma display of this embodiment differs from embodiment 1 only in the structure of the scan electrode driving section 11.

3.1 Scan Electrode Driving Section

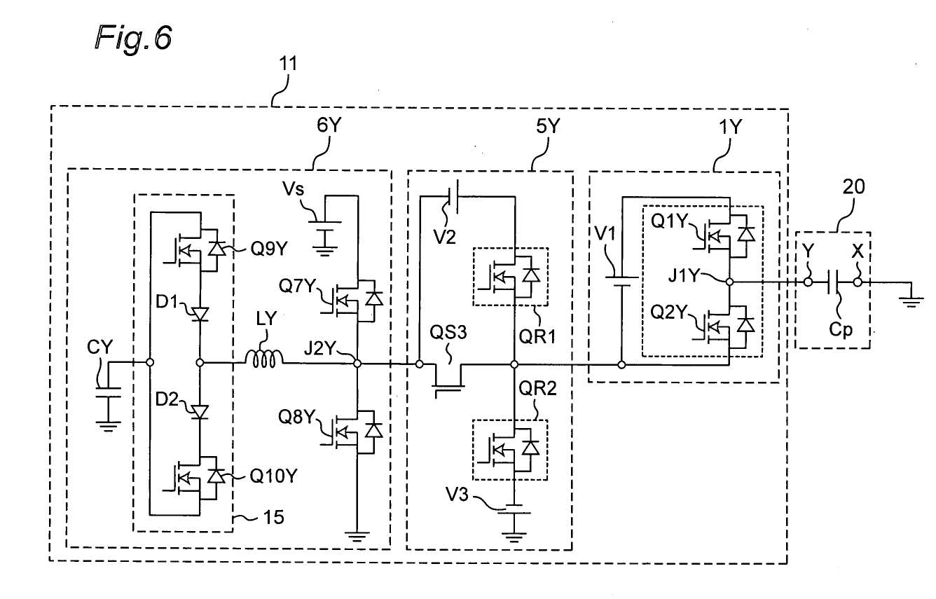

FIG. 6 shows the scan electrode driving section 11 in embodiment 3 of the invention.

The scan electrode driving section 11 of the present embodiment differs from embodiment 1 shown in FIG. 2 in the structure of the reset pulse generating section and sustain pulse generating section. The other components are same as in embodiment 1.

The reset pulse generating section 5Y of the present embodiment has a separation switch element QS3, in addition to the structure of the reset pulse generating section 5Y of embodiment 1. This separation switch element QS3 is formed of a bidirectional switch element. The separation switch element QS3 has its source connected to the negative electrode of the second constant voltage source V2, and its drain connected to the negative electrode of the first constant voltage source V1. In this embodiment, the negative electrode of the second constant voltage source V2 is not connected to the positive electrode of the sustain voltage source Vs, but is connected to the junction JY2. In this respect too, it is different from embodiment 1.

Aside from the structure shown in FIG. 6, the source of the separation switch element QS3 may be connected to the negative electrode of the first constant voltage source V1, and the drain of the separation switch element QS3 may be connected to the negative electrode of the second constant voltage source V2.

The sustain pulse generating section 6Y of the embodiment is similar to embodiment 1, except that the high side sustain switch element Q7Y and low side sustain switch element Q8Y are formed of MOSFET. However, sustain switch elements Q7Y and Q8Y may be formed of IGBT or bipolar transistor, or bidirectional switch element same as in embodiment 1.

In the circuit structure shown in FIG. 6, the recovery switch circuit 15 may be replaced by the recovery switch element Q11Y same as in embodiment 2.

The separation switch element can be applied not only to the scan electrode (scan electrode driving section 11), but also to the sustain electrode (sustain electrode driving section 12) and address electrode (address electrode driving section 13).

3.2 Operation

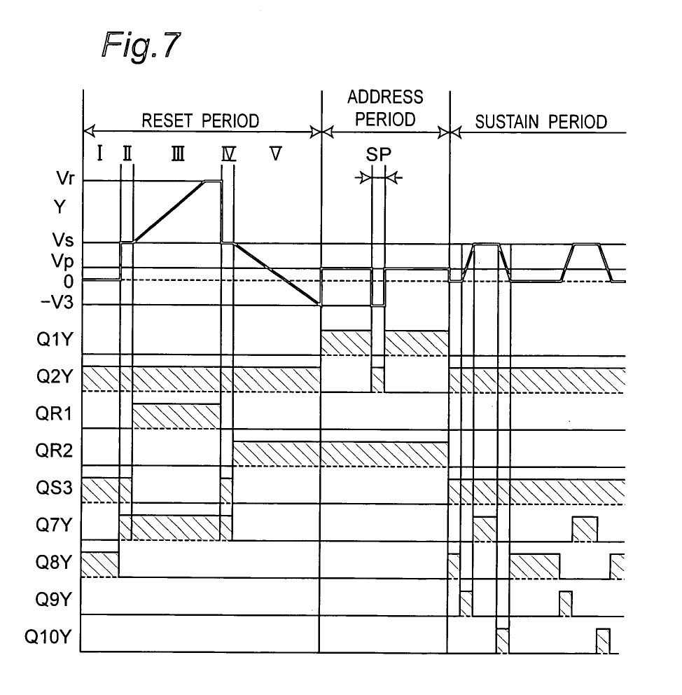

FIG. 7 is an applied voltage waveform diagram of the scan electrode Y of the PDP 20 during a reset period, an address period, and a sustain period, and a diagram showing ON period of each switch element included in the scan electrode driving section 11. In FIG. 7, the ON period of each switch element is indicated in shaded area. Operation in each period is explained below.

3.2.1 Reset Period

Operation is classified into five modes I to V as follows depending on change in reset pulse voltage.

<Mode I>

In the scan electrode driving section 11, the low side scan switch element Q2Y, separation switch element QS3, and low side sustain switch element Q8Y are maintained in ON state. The other switch elements are maintained in OFF state. As a result, the scan electrode Y is maintained at ground potential (about zero).

<Mode II>

In the scan electrode driving section 11, the low side scan switch element Q2Y, separation switch element QS3, and high side sustain switch element Q7Y are maintained in ON state. The other switch elements are maintained in OFF state. As a result, the potential of the scan electrode Y is elevated to a potential higher than ground potential (about zero) by voltage Vs of the sustain voltage source Vs.

<Mode III>

In the scan electrode driving section 11, while the low side scan switch element Q2Y and high side sustain switch element Q7Y are maintained in ON state, the separation switch element QS3 is turned off, and the high side lamp waveform generating section QR1 is turned on. As a result, the potential of the scan electrode Y is elevated, at a specific speed, to potential Vr (upper limit of the reset pulse voltage) higher than ground potential (about zero) by the sum of voltage Vs of the sustain voltage source Vs and voltage V2 of the second constant voltage source.

Thus, equally in all discharge cells of the PDP 20, the applied voltage elevates slowly to the upper limit Vr of the reset pulse voltage. At this time, since the elevation speed of the applied voltage is slow, light emission of discharge cells is suppressed low.

<Mode IV>

In the scan electrode driving section 11, while the low side scan switch element Q2Y and high side sustain switch element Q7Y are maintained in ON state, the high side lamp waveform generating section QR1 is turned off, and the separation switch element QS3 is turned on. The other switch elements are maintained in OFF state. As a result, the potential of the scan electrode Y is lowered to a potential higher than ground potential (about zero) by voltage Vs of the sustain voltage source Vs.

<Mode V>

In the scan electrode driving section 11, while the low side scan switch element Q2Y is maintained in ON state, the separation switch element QS3 and high side sustain switch element Q7Y are turned off, and the low side lamp waveform generating section QR2 is turned on. The other switch elements are maintained in OFF state. As a result, the potential of the scan electrode Y is lowered to a potential −V3 lower than ground potential (about zero) by voltage V3 of the third constant voltage source. Therefore, discharge cells of the PDP 20 are applied with a voltage in reverse polarity of the voltage applied in modes II to IV. In particular, the applied voltage descends relatively slowly. As a result, wall charge is removed uniformly in all discharge cells, and is equalized. At this time, the descending speed of the applied voltage is slow, and thus light emission of discharge cells is suppressed low.

3.2.2 Address Period

Operation in the address period of the present embodiment is same as explained in embodiment 1.

3.2.3 Sustain Period

During the sustain period, the separation switch element QS3 and the low side scan switch element Q2Y are always maintained in ON state.

Operation of other switching elements in the sustain period is same as explained in embodiment 1.

3.3 Summary

According to the present embodiment, as shown in FIG. 6, the separation switch element QS3 as bidirectional switch element is provided in a path extending from the output terminal of the sustain pulse generating section 6Y (junction of sustain switch elements Q7Y and Q8Y) JY2 to the source of the low side scan switch element Q2Y. As a result, the potential change range at the output terminal JY2 of the sustain pulse generating section 6Y is controlled from Vs to 0. In the conventional structure shown in FIG. 8, the potential change range at the output terminal JY2 of the sustain pulse generating section 113 ranges from (Vs+V2) to −V3. Thus, according to the present embodiment, as compared with the prior art, the potential change range at the output terminal JY2 of the sustain pulse generating section 6Y becomes narrower. That is, in the present embodiment, parts having lower absolute maximum rating for drain to source voltage and source to drain voltage may be used in switch elements in the sustain pulse generating section 6Y. Generally, in the relation between absolute maximum rating for drain to source voltage and source to drain voltage and resistance of the silicon semiconductor per unit area, the resistance increases 5 times as the absolute maximum rating for drain to source voltage and source to drain voltage increases 2 times. Thus amount of current which can be flowed decreases significantly as the absolute maximum rating for drain to source voltage and source to drain voltage increases. In the embodiment, accordingly, as compared with the prior art, the number of switch elements disposed in parallel in the sustain pulse generating section 6Y can be saved, and the mounting area is decreased. In particular, since a large current flows in switch elements Q7Y, Q8Y, Q9Y and Q10Y of the sustain pulse generating section, decreasing the resistance of each switch element can reduce the number of parts disposed in parallel. Hence the present invention is very significant. Also since the mounting area is smaller, wiring impedance due to the circuit board is smaller, ringing of high frequency component occurring at the time of application of voltage to the PDP is smaller, and the operation margin of the PDP is expanded. Conventionally, in order not to clamp the scan pulse voltage by the upper limit or lower limit of the sustain voltage source, two types of separation switch elements had to be provided at position of a bidirectional switch element. However, in the present embodiment, replacing by bidirectional switch elements as in the present embodiment can reduce two types of separation switch elements. As described above, since multiple separation switch elements must be connected in parallel, according to the embodiment not using separation switch elements, the circuit scale is reduced effectively. This can saves the mounting area. Wiring impedance due to the circuit board is reduced. Ringing of high frequency component occurring at the time of application of voltage to the PDP is curtailed. Thus the operation margin of the PDP is expanded. Further, conduction loss by separation switch elements in the sustain period is substantially decreased, and the power consumption can be saved sufficiently.

### INDUSTRIAL APPLICABILITY

The invention relates to the PDP driving apparatus, and realizes saving of number of parts, mounting area, and power consumption, by the use of bidirectional switch elements and modification of circuit as described herein. Thus, the industrial applicability of the invention is outstanding.

Having described preferred embodiments of the invention with reference to the accompanying drawings, it is to be understood that the invention is not limited to those precise embodiments, and that various changes and modifications may be effected therein by those skilled in the art without departing from the scope or spirit of the invention as defined in the appended claims.

What is claimed is:

1. A PDP driving apparatus for driving a plasma display panel having sustain electrodes, scan electrodes, and address electrodes, comprising:
a high side switch element, and a low side switch element, those electrically coupled in series,
wherein a specific pulse voltage is applied from a junction point of the high side switch element and the low side switch element to at least scan electrodes, sustain electrodes, or address electrodes of the plasma display panel, and
at least one of the high side switch element and the low side switch element is a bidirectional switch element.

2. The PDP driving apparatus according to claim 1, further comprising an inductor connected to the junction point, and a recovery switch element operable to form, in ON period, a path of flow of a resonance current by the inductor and the plasma display panel,
wherein the recovery switch element is a bidirectional switch element.

3. The PDP driving apparatus according to claim 1, wherein the bidirectional switch element includes at least one of JFET, MESFET, reverse blocking IGBT, and bidirectional lateral MOSFET.

4. The PDP driving apparatus according to claim 1, wherein the bidirectional switch element is formed of wide band gap semiconductor.

5. The PDP driving apparatus according to claim 4, wherein the wide band gap semiconductor contains at least one of silicon carbide, diamond, gallium nitride, and zinc oxide.

6. A PDP driving apparatus for driving a plasma display panel having sustain electrodes, scan electrodes, and address electrodes, comprising:
a high side switch element and a low side switch element, those electrically coupled in series,
wherein a specific pulse voltage is applied from a junction point of the high side switch element and the low side switch element to at least scan electrodes, sustain electrodes, or address electrodes of the plasma display panel, and
a separate switch element is provided between the junction and the plasma display panel, and the separate switch element is a bidirectional switch element.

7. The PDP driving apparatus according to claim 6, further comprising an inductor connected to the junction point, and a recovery switch element operable to form, in ON period, a path of flow of a resonance current by the inductor and the plasma display panel,
wherein the recovery switch element is a bidirectional switch element.

8. The PDP driving apparatus according to claim 5, wherein the bidirectional switch element includes at least one of JFET, MESFET, reverse blocking IGBT, and bidirectional lateral MOS FET.

9. The PDP driving apparatus according to claim 5, wherein the bidirectional switch element is formed of wide band gap semiconductor.

10. The PDP driving apparatus according to claim 9, wherein the wide band gap semiconductor contains at least one of silicon carbide, diamond, gallium nitride, and zinc oxide.

11. A PDP driving apparatus for driving a plasma display panel having sustain electrodes, scan electrodes, and address electrodes, comprising:
an inductor electrically coupled to at least sustain electrodes, scan electrodes, or address electrodes, and
a recovery switch element operable to form, in ON period, a path of flow of a resonance current by the inductor and the plasma display panel,
wherein the recovery switch is a bidirectional switch element.

12. The PDP driving apparatus according to claim 11, wherein the bidirectional switch element includes at least one of JFET, MESFET, reverse blocking IGBT, and bidirectional lateral MOS FET.

13. The PDP driving apparatus according to claim 12, wherein the bidirectional switch element is formed of wide band gap semiconductor.

14. The PDP driving apparatus according to claim 13, wherein the wide band gap semiconductor contains at least one of silicon carbide, diamond, gallium nitride, and zinc oxide.

15. A plasma display comprising:
a plasma display panel having sustain electrodes, scan electrodes, and address electrodes, and
a PDP driving apparatus according to claim 1, operable to drive the plasma display panel.

16. A plasma display comprising:
a plasma display panel having sustain electrodes, scan electrodes, and address electrodes, and
a PDP driving apparatus according to claim 6, operable to drive the plasma display panel.

17. A plasma display comprising:
a plasma display panel having sustain electrodes, scan electrodes, and address electrodes, and
a PDP driving apparatus according to claim 11 operable to drive the plasma display panel.

18. A PDP driving apparatus for driving a plasma display panel capable of displaying an image by light emission due to discharge between electrodes, comprising:
an electrode driving section operable to apply a specific voltage to the electrodes,
wherein the electrode driving section includes a bidirectional switch element.

19. The PDP driving apparatus according to claim 18, wherein the bidirectional switch element includes at least one of JFET, MESFET, reverse blocking IGBT, and bidirectional lateral MOSFET.

20. The PDP driving apparatus according to claim 18, wherein the bidirectional switch element is formed of wide band gap semiconductor.

21. The PDP driving apparatus according to claim 20, wherein the wide band gap semiconductor contains at least one of silicon carbide, diamond, gallium nitride, and zinc oxide.

22. A plasma display comprising:
a plasma display panel capable of displaying an image by light emission due to discharge between electrodes, and
a PDP driving apparatus according to claim 18, operable to drive the plasma display panel.
